(19) United States
(12) Patent Application Publication
(10) Pub. No.: US 2022/0102064 A1
(43) Pub. Date: Mar. 31, 2022

(54) INDUCTOR

(71) Applicant: Murata Manufacturing Co., Ltd., Kyoto-fu (JP)

(72) Inventors: Shu HAMADA, Nagaokakyo-shi (JP); Hiroya UEYAMA, Nagaokakyo-shi (JP)

(73) Assignee: Murata Manufacturing Co., Ltd., Kyoto-fu (JP)

(21) Appl. No.: 17/545,946

(22) Filed: Dec. 8, 2021

Related U.S. Application Data
(63) Continuation of application No. PCT/JP2020/023262, filed on Jun. 12, 2020.

(30) Foreign Application Priority Data
Jul. 11, 2019 (JP) 2019-129153

(51) Int. Cl. H01F 27/29; H01F 27/02

(52) U.S. Cl. CPC H01F 27/292; H01F 27/02

(57) ABSTRACT

An inductor includes a rectangular parallelepiped shaped housing, a conical coil buried inside the housing, a first outer electrode provided on a first end portion of a substrate mounting surface of the housing, and a second outer electrode provided on a second end portion of the substrate mounting surface of the housing. The conical coil is formed of the coil conductor, which is wound in a spiral shape. A winding axis direction of the conical coil is tilted with respect to the substrate mounting surface of the housing. Two ends of the coil conductor are connected to the first outer electrode and the second outer electrode so that end portions of the coil conductor are at a side near the substrate mounting surface of the housing.

### CROSS-REFERENCE TO RELATED APPLICATIONS

This application claims benefit of priority to International Patent Application No. PCT/JP2020/023262, filed Jun. 12, 2020, and to Japanese Patent Application No. 2019-129153, filed Jul. 11, 2019, the entire contents of each are incorporated herein by reference.

### BACKGROUND

### Technical Field

The present disclosure relates to an inductor that includes a conical coil.

### Background Art

An inductor that includes a conical coil is known, as described, for example, in Japanese Unexamined Patent Application Publication No. 2017-108058 and Japanese Unexamined Patent Application Publication No. 2009-231518. Japanese Unexamined Patent Application Publication No. 2017-108058 discloses a chip-type inductor in which a winding is wound around a core. In the inductor disclosed in Japanese Unexamined Patent Application Publication No. 2017-108058, the winding is wound around a dog-bone-shaped core that has different diameters at the beginning and end of the coil winding, and a resistive conductor is placed flat on the top surface of the core. In addition, an inductor that is not equipped with a housing exterior and in which a winding is wound around a core is disclosed in Japanese Unexamined Patent Application Publication No. 2009-231518. The inductor disclosed in Japanese Unexamined Patent Application Publication No. 2009-231518 is designed to have reduced floating inductance values by adopting a structure in which lead out electrodes (leads) led out from a coil are shortened or omitted. In this case, since the lead out electrodes are short, the coil is attached to a mounting substrate with the winding axis of the coil tilted.

### SUMMARY

In the inductor described in Japanese Unexamined Patent Application Publication No. 2017-108058, a copper wire is wound around a core that is flange shaped at both ends and therefore floating inductances are generated in the regions where the wire is led out to external electrodes. In addition, the winding cannot be formed on the flange parts and the volume of the winding part in the effective volume of the chip is reduced. Furthermore, since the copper wire is wound around the core, the strength of the core cannot be maintained if the core is made narrower, and therefore it is difficult to reduce the winding diameter and there is a tendency for the inductor to be increased in size.

On the other hand, the inductor described in Japanese Unexamined Patent Application Publication No. 2009-231518 does not have leads that are led out to the exterior from the coil, so when the inductor is made into a small chip, it is difficult to pick up the chip while mounting the chip. In addition, an electrode is provided at the tip of a small-diameter part of the coil in order to allow connection to a substrate. However, as the diameter of the tip of the coil becomes smaller, the outer electrode also becomes smaller, and therefore there is a problem that solderability is degraded.

Accordingly, an embodiment of the present disclosure provides an inductor in which floating inductances can be suppressed and that can be reduced in size.

An embodiment of the present disclosure provides an inductor that includes a rectangular parallelepiped shaped housing formed of an insulating material, a conical coil buried inside the housing, a first outer electrode provided at a first end portion of a substrate mounting surface of the housing, and a second outer electrode provided at a second end portion of the substrate mounting surface of the housing. The conical coil is formed of a spirally wound coil conductor buried inside the housing. A winding axis direction of the conical coil is tilted with respect to the substrate mounting surface of the housing. Two ends of the coil conductor are connected to the first outer electrode and the second outer electrode, which are positioned at two ends of the substrate mounting surface of the housing, so that end portions of the coil conductor are at a side near the substrate mounting surface of the housing.

According to the embodiment of the present disclosure, floating inductances can be suppressed and an inductor can be reduced in size.

### BRIEF DESCRIPTION OF THE DRAWINGS

FIG. 1 is a perspective view illustrating an inductor according to an embodiment of the present disclosure;

FIG. 2 is a plan view illustrating the inductor in FIG. 1;

FIG. 3 is a sectional view in which the inductor is viewed in the direction of arrows III-III in FIG. 2;

FIG. 4 is a plan view illustrating an inductor according to a first Modification; and

FIG. 5 is a sectional view illustrating an inductor according to a second modification and taken at the same position as FIG. 3.

### DETAILED DESCRIPTION

Hereafter, an inductor according to an embodiment of the present disclosure will be described in detail while referring to the accompanying drawings.

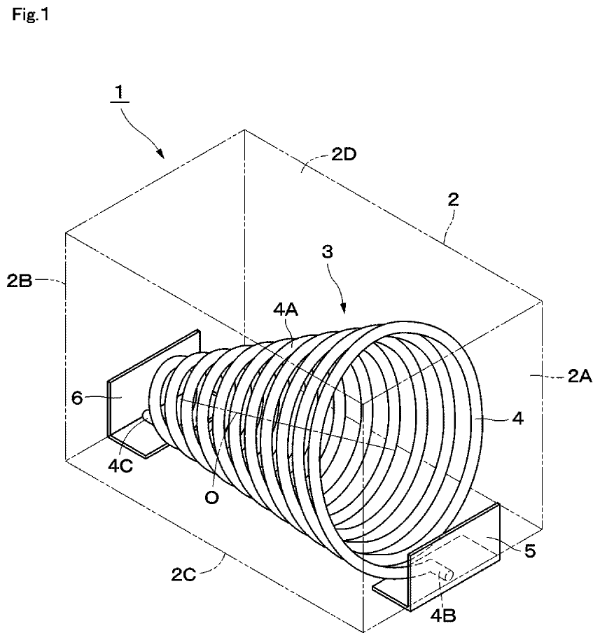

FIGS. 1 to 3 illustrate an inductor 1 according to an embodiment of the present disclosure. The inductor 1 includes a housing 2, a conical coil 3, a first outer electrode 5, and a second outer electrode 6.

The housing 2 (package) is formed of an insulating material such as a ceramic material, for example. The insulating material of the housing 2 may be a magnetic material or may be a non-magnetic material. The insulating material of the housing 2 may be a dielectric material or may be a resin material. The housing 2 is formed in a rectangular parallelepiped shape, for example. The housing 2 has a first main surface 2A (first end surface) and a second main surface 2B (second end surface), which face each other. The housing 2 has a substrate mounting surface 2C, which is a bottom surface, and a top surface 2D, which faces the substrate mounting surface 2C. The first main surface 2A and the second main surface 2B are located at a first end portion and a second end portion of the substrate mounting surface 2C in a length direction of the substrate mounting surface 2C (left-right direction in FIG. 3).

As illustrated in FIGS. 1 to 3, the conical coil 3 is formed of a spirally wound coil conductor 4 that is buried inside the insulating material of the housing 2. Therefore, the conical coil 3 is provided inside the housing 2. The conical coil 3 is formed of the coil conductor 4 wound in a spiral shape. As an electrically conductive material, the coil conductor 4 is formed of an electrically conductive metal material such as copper, nickel, or silver. The coil conductor 4 is formed in a long thin strip shape.

The coil conductor 4 includes a coil part 4A wound in a conical shape, an electrode connection part 4B connected to a first end portion of the coil part 4A, and an electrode connection part 4C connected to a second end portion of the coil part 4A. The two ends of the coil conductor 4 are electrically connected to the first outer electrode 5 and the second outer electrode 6, which are located at the two ends of the substrate mounting surface 2C of the housing 2, so that the end portions of the coil conductor 4 are at the side near the substrate mounting surface 2C (substrate side) of the housing. At this time, the first end portion of the coil conductor 4 is located on the largest diameter side of the conical coil 3 and is a large-diameter-side end portion of the conical coil 3. The first end portion of the coil conductor 4 forms the electrode connection part 4B. The electrode connection part 4B is disposed at a position near the substrate mounting surface 2C of the housing 2 and near the first main surface 2A of the housing 2. The second end portion of the coil conductor 4 is disposed on the smallest-diameter-side of the conical coil 3 and forms a small-diameter-side end portion of the conical coil 3. The second end portion of the coil conductor 4 forms the electrode connection part 4C. The electrode connection part 4C is disposed at a position near the substrate mounting surface 2C of the housing 2 and near the second main surface 2B of the housing 2.

A winding axis direction (winding axis O) of the conical coil 3 is tilted with respect to the substrate mounting surface 2C of the housing 2. Here, the conical coil 3 has a conical shape. The conical coil 3 is disposed so that the outer peripheral surface of the conical coil 3 extends along the substrate mounting surface 2C. The winding axis O (center axis) of the conical coil 3 passes through a plane that is perpendicular to the substrate mounting surface 2C. On the side near the first main surface 2A where the outer diameter dimension of the conical coil 3 is large, the winding axis O of the conical coil 3 is disposed at a position that is spaced apart from the substrate mounting surface 2C. Specifically, the part of the winding axis O on the largest-diameter side of the conical coil 3 is separated from the substrate mounting surface 2C by a distance substantially equal to the largest-diameter-side radius of the conical coil 3.

In contrast, on the side near the second main surface 2B where the outer diameter dimension of the conical coil 3 is small, the winding axis O of the conical coil 3 is disposed at a position that is near the substrate mounting surface 2C. In other words, the winding axis O is nearer the substrate mounting surface 2C on the smallest-diameter side of the conical coil 3 than on the largest-diameter side of the conical coil 3. Therefore, the winding axis O of the conical coil 3 becomes closer to the substrate mounting surface 2C as the winding axis O approaches the second main surface 2B from the first main surface 2A.

As illustrated in FIG. 3, the coil conductor 4 has a rectangular cross-sectional shape. The long sides of the cross section of the coil conductor 4 are parallel to the first main surface 2A and the second main surface 2B. When, for example, the housing 2 and the conical coil 3 are formed by stacking layers parallel to the first main surface 2A and the second main surface 2B, the accuracy with which the conical coil 3 is positioned is high. The winding diameter of the conical coil 3 increases continuously as the conical coil 3 approaches the first main surface 2A from the second main surface 2B. The insulating material of the housing 2 is disposed without any gaps around the periphery of the coil conductor 4.

The first outer electrode 5 is provided on the housing 2. The first outer electrode 5 is connected to the first end portion (electrode connection part 4B) of the coil conductor 4. The first outer electrode 5 is, for example, formed of an electrically conductive metal material, serving as a conductive material. The first outer electrode 5 is formed so as to be bent in an L shape and extends from the first main surface 2A onto the substrate mounting surface 2C of the housing 2.

At this time, the electrode connection part 4B of the coil conductor 4 is disposed next to the first outer electrode 5. In other words, the electrode connection part 4B is formed so as to be continuous with the first end portion of the coil part 4A. Therefore, the length dimension from the coil part 4A to the electrode connection part 4B is shorter than in a case where the electrode connection part 4B and the first outer electrode 5 are disposed so as to be spaced apart from each other.

The second outer electrode 6 is provided on the housing 2. The second outer electrode 6 is connected to the second end portion (electrode connection part 4C) of the coil conductor 4. The second outer electrode 6 is, for example, formed of an electrically conductive metal material, serving as a conductive material. The second outer electrode 6 is formed so as to be bent into an L shape and extends from the second main surface 2B onto the substrate mounting surface 2C of the housing 2. The first outer electrode 5 and the second outer electrode 6 are disposed so as to be separated from each other.

At this time, the electrode connection part 4C of the coil conductor 4 is disposed next to the second outer electrode 6. In other words, the electrode connection part 4C is formed so as to be continuous with the second end portion of the coil part 4A. Therefore, the length dimension from the coil part 4A to the electrode connection part 4C is shorter than in a case where the electrode connection part 4C and the second outer electrode 6 are disposed so as to be spaced apart from each other.

The inductor 1 according to an embodiment of the present disclosure has the above-described configuration. The inductor 1 is manufactured using a manufacturing method including the three steps described below.

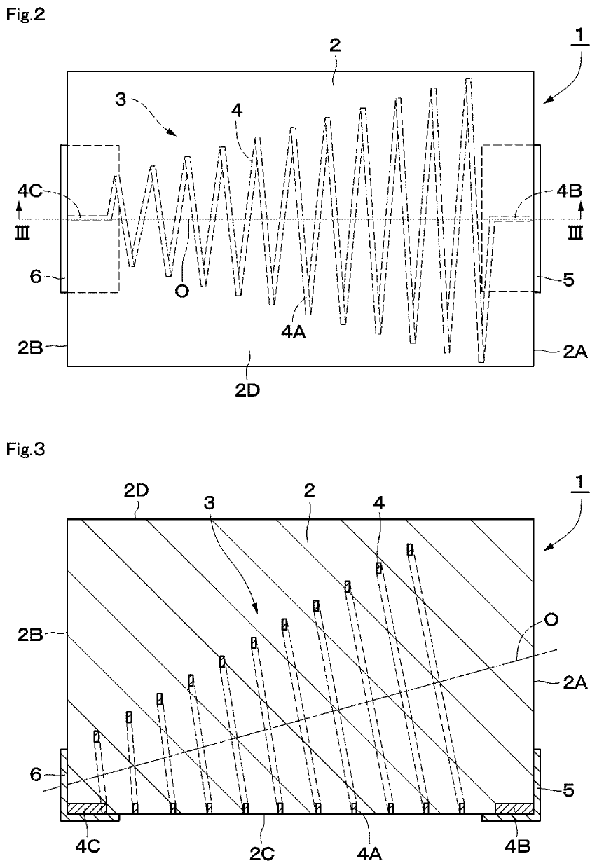

In a first step, an insulator ink consisting of ceramic particles, an organic binder, and a solvent, and a conductor ink consisting of metal particles, an organic binder, and a solvent are ejected using an inkjet method, and volatilization and drying of the solvent in each ink are repeatedly performed. At this time, layers consisting of ceramic particles and metal particles are stacked one layer at a time along the length direction (left-right direction in FIG. 2) of the housing 2, for example. Each layer is, for example, formed parallel to the first main surface 2A and the second main surface 2B. In this way, molded bodies consisting of ceramic particles, metal particles, and organic components are formed. The molded bodies do not have to be stacked in the length direction of the housing 2 and may instead be stacked in the height direction of the housing 2.

In a second step (degreasing step), the organic components of the molded bodies formed in the first step are removed. In a third step (firing step), the molded bodies from which the organic components were removed in the second step are heated and the insulators and conductors are simultaneously sintered. Thus, the housing 2 having the built-in conical coil 3 is formed.

After that, the first outer electrode 5 and the second outer electrode 6 are attached to the housing 2. Thus, the inductor 1 is completed. At this time, the first outer electrode 5 is located on the first main surface 2A side of the housing 2 and is electrically connected to the first end portion (electrode connection part 4B) of the conical coil 3. The second outer electrode 6 is located on the second main surface 2B side of the housing 2 and is electrically connected to the second end portion (electrode connection part 4C) of the conical coil 3.

Thus, in the inductor 1 according to this embodiment, the two ends of the coil conductor 4 are connected to the first outer electrode 5 and the second outer electrode 6, which are located at the two ends of the substrate mounting surface 2C of the housing 2, so that the end portions of the coil conductor 4 are at a side near the substrate mounting surface 2C of the housing 2. Thus, a line from the winding part of the coil conductor 4 to the first outer electrode 5 or the second outer electrode 6 is shortened compared to the inductor disclosed in Japanese Unexamined Patent Application Publication No. 2017-108058. Therefore floating inductances are reduced.

Furthermore, the shapes of the first outer electrode 5 and the second outer electrode 6 can be made identical on the left and right sides. Therefore, it is easier to mount the inductor 1 compared with the inductor disclosed in Japanese Unexamined Patent Application Publication No. 2009-231518. In addition, since the housing 2 has a rectangular parallelepiped shape, it can be easily picked up using an automatic mounting machine.

Furthermore, the inductor 1 is formed by sequential stacking rather than by winding a winding around a core. Therefore, the radial-direction dimension of the conical coil 3 can be made smaller and the inductor 1 can be reduced in size. In addition, the conical coil 3 is disposed so as to be tilted inside the rectangular parallelepiped shaped housing 2. Therefore, the largest diameter of the conical coil 3 can be larger than the height dimension of the housing 2. As a result, an inductance value can be obtained across a wide band from a high-frequency band corresponding to the small-diameter part of the conical coil 3 to a low-frequency band corresponding to the large-diameter part of the conical coil 3.

In this embodiment, it is assumed that the cross section of the coil conductor 4 is formed in a rectangular shape. The present disclosure is not limited to this configuration, and the cross section of the coil conductor 4 may instead be a square shape or may be a circular or elliptical shape.

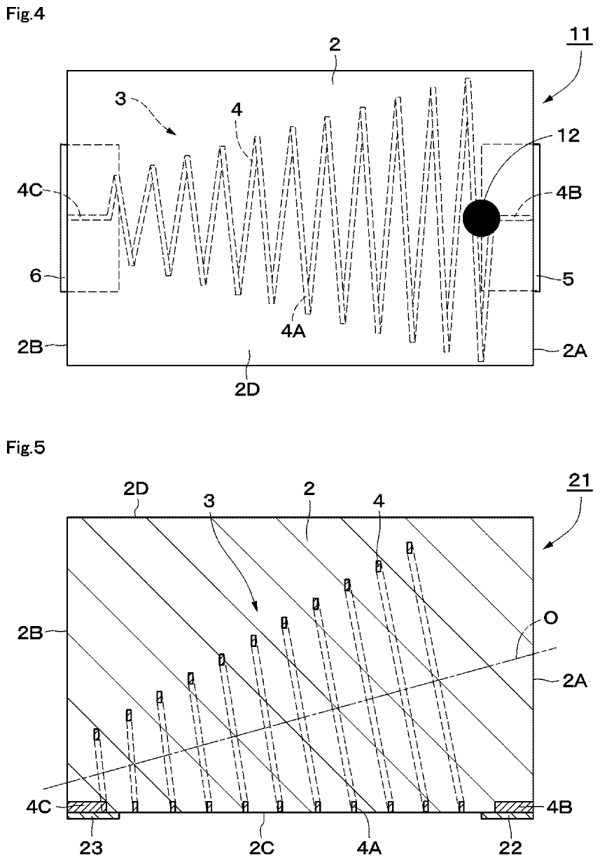

Furthermore, a mark 12 for identifying the polarity of the conical coil 3 may be formed on the top surface 2D of the housing 2 as in an inductor 11 according to a first Modification illustrated in FIG. 4. Here, the polarity identifier is not limited to the mark 12. For example, half of the top surface 2D, in the length direction of the housing 2, may be painted in a different color from the rest of the top surface 2D and used as a polarity identifier.

In addition, in this embodiment, the first outer electrode 5 is formed so as to extend from the first main surface 2A onto the substrate mounting surface 2C and the second outer electrode 6 is formed so as to extend from the second main surface 2B onto the substrate mounting surface 2C. The present disclosure is not limited to this configuration, and a first outer electrode 22 and a second outer electrode 23 may be formed on the substrate mounting surface 2C as in an inductor 21 according to a second Modification illustrated in FIG. 5. In this case, the first outer electrode 22 does not include a part that faces the first main surface 2A. Similarly, the second outer electrode 23 does not include a part that faces the second main surface 2B.

In addition, in the above embodiment, it is assumed that the housing 2 is formed of a material that is homogeneous throughout the entire housing 2. The present disclosure is not limited to this configuration, and a core may be formed inside the housing, for example, in an inner radial part of the conical coil 3, by filling the inside of the inner radial part with a material having a higher magnetic permeability than the rest of the housing.

Next, the inductors included in the above embodiments may include inductors according to the following aspects, for example.

An inductor of a first Aspect includes a rectangular parallelepiped shaped housing formed of an insulating material, a conical coil buried inside the housing, a first outer electrode provided at a first end portion of a substrate mounting surface of the housing, and a second outer electrode provided at a second end portion of the substrate mounting surface of the housing. The conical coil is formed of a spirally wound coil conductor buried inside the housing. A winding axis direction of the conical coil is tilted with respect to the substrate mounting surface of the housing. Two ends of the coil conductor are connected to the first outer electrode and the second outer electrode, which are positioned at two ends of the substrate mounting surface of the housing, so that end portions of the coil conductor are at a side near the substrate mounting surface of the housing.

At this time, the two ends of the coil conductor are connected to the first outer electrode and the second outer electrode, which are located at the two ends of the substrate mounting surface of the housing, so that the end portions of the coil conductor are at a side near the substrate mounting surface of the housing. As a result, a line from a winding part of the coil conductor to the first outer electrode or the second outer electrode is short, and therefore a floating inductance is reduced.

Furthermore, the shapes of the first outer electrode and the second outer electrode can be made identical on the left and right sides, and therefore it is easy to mount the inductor. In addition, since the housing has a rectangular parallelepiped shape, the inductor is easy to pick up using an automatic mounting machine.

Furthermore, in the inductor, the conical coil is buried inside the housing without a winding being wound around a core. Therefore, the radial-direction dimension of the conical coil can be made smaller and the inductor can be reduced in size. In addition, the conical coil is disposed so as to be tilted inside the rectangular parallelepiped shaped housing. Therefore, the largest diameter of the conical coil can be larger than the height dimension of the housing. As a result, the inductor can realize an inductance value across a wide band.

What is claimed is:

1. An inductor comprising:
a rectangular parallelepiped shaped housing formed of an insulating material;
a conical coil buried inside the housing;
a first outer electrode provided on a first end portion of a substrate mounting surface of the housing; and
a second outer electrode provided on a second end portion of the substrate mounting surface of the housing,
wherein the conical coil is formed of a spirally wound coil conductor buried inside the housing,
a winding axis direction of the conical coil is tilted with respect to the substrate mounting surface of the housing, and
two ends of the coil conductor are respectively connected to the first outer electrode and the second outer electrode, which are located at two ends of the substrate mounting surface of the housing, so that end portions of the coil conductor are at a side near the substrate mounting surface of the housing.

2. The inductor according to claim 1, wherein
a winding diameter of the conical coil increases continuously in the winding axis direction from a first of the two ends of the substrate mounting surface to a second of the two ends of the substrate mounting surface.

3. The inductor according to claim 1, further comprising:
a first electrode connection part that connects the first electrode to a first one of the two ends of the coil conductor, and a second electrode connection part that connects the second electrode to a second one of the two ends of the coil conductor.

4. The inductor according to claim 3, wherein
each of the first and second electrode connection parts extend along a direction between the two ends of the substrate mounting surface.

5. The inductor according to claim 2, further comprising:
a first electrode connection part that connects the first electrode to a first one of the two ends of the coil conductor, and a second electrode connection part that connects the second electrode to a second one of the two ends of the coil conductor.

6. The inductor according to claim 5, wherein
each of the first and second electrode connection parts extend along a direction between the two ends of the substrate mounting surface.
